(19) United States
(12) Patent Application Publication
(10) Pub. No.: US 2025/0123971 A1
(43) Pub. Date: Apr. 17, 2025

(54) ELECTRONIC DEVICE AND METHOD WITH EFFICIENT MEMORY MANAGEMENT

(71) Applicant: Samsung Electronics Co., Ltd., Suwon-si (KR)

(72) Inventors: Jungsik CHOI, Suwon-si (KR); Ruth KIM, Suwon-si (KR); Seok-Young YOON, Suwon-si (KR)

(73) Assignee: Samsung Electronics Co., Ltd., Suwon-si (KR)

(21) Appl. No.: 18/755,026

(22) Filed: Jun. 26, 2024

(30) Foreign Application Priority Data
Oct. 16, 2023 (KR) 10-2023-0138034

(51) Int. Cl. G06F 12/1036; G06F 12/0873

(52) U.S. Cl. CPC G06F 12/1036; G06F 12/0873; G06F 2212/656

(57) ABSTRACT

A processor-implemented method includes receiving a mapping instruction to map target data onto a process address space, in response to reception of the mapping instruction, marking an unused node in a tree that manages the process address space as a use node to reuse, and mapping the target data onto a virtual area in the process address space, wherein the tree manages the virtual area onto which the target data is mapped as the use node.

### CROSS-REFERENCE TO RELATED APPLICATIONS

This application claims the benefit under 35 USC § 119(a) of Korean Patent Application No. 10-2023-0138034, filed on Oct. 16, 2023 in the Korean Intellectual Property Office, the entire disclosure of which is incorporated herein by reference for all purposes.

### BACKGROUND

### 1. Field

The following description relates to an electronic device and method with efficient memory management.

### 2. Description of Related Art

Applications may secure most of the required memory in advance at startup. Applications may manage the memory using a memory allocator rather than an operating system to avoid overhead. For example, an application may minimize memory allocation and deallocation to an operating system by internally processing memory allocation and deallocation without support from the operating system. Therefore, the operating system may recognize the size of the memory secured by the application and may not know how the application uses the secured memory.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: receiving a mapping instruction to map target data onto a process address space; in response to reception of the mapping instruction, marking an unused node in a tree that manages the process address space as a use node to reuse; and mapping the target data onto a virtual area in the process address space, wherein the tree manages the virtual area onto which the target data is mapped as the use node.

The tree may manage the process address space using a plurality of use nodes corresponding to a plurality of virtual areas in which data is mapped onto the process address space and one or more unused nodes that do not correspond to the plurality of virtual areas.

The tree may include a self-balancing binary search tree.

The marking of the unused node as the use node to reuse may include: setting a lock enabling a read operation to the tree; searching for a space to be mapped with the target data in the process address space; determining whether the unused node exists in the tree; and in response to the unused node existing in the tree, marking the unused node as the use node.

The marking of the unused node as the use node to reuse may include searching for an initial node using the tree and searching for the unused node from the initial node using a list indicating an address order of a plurality of virtual areas comprised in the process address space.

The data may include one or more tensors.

Virtual areas comprised in the process address space may be managed by one or more groups in response to a grouping instruction to group the virtual areas as the one or more groups, and virtual areas comprised in one of the one or more groups may be concurrently processed with respect to an arbitrary instruction.

The method may include: receiving an unmapping instruction to cancel mapping of data for a target virtual area in the process address space; in response to reception of the unmapping instruction, marking another use node in the tree as another unused node; and unmapping data for the target virtual area, wherein the tree manages the other unused node to reuse in future.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes: receiving an unmapping instruction to cancel mapping of data for a target virtual area in a process address space; in response to reception of the unmapping instruction, marking a use node in a tree corresponding to the target virtual area as an unused node; and unmapping data for the target virtual area, wherein the tree manages the unused node to reuse in future.

The tree may manage the process address space using a plurality of use nodes corresponding to a plurality of virtual areas in which data is mapped onto the process address space and one or more unused nodes that do not correspond to the plurality of virtual areas.

The tree may include a self-balancing binary search tree.

The marking of the use node as an unused node may include: setting a lock enabling a read operation to the tree; searching for the use node corresponding to the target virtual area in the tree; determining whether a depth of the use node searched in the tree exceeds a threshold depth; and in response to the depth of the searched use node not exceeding the threshold depth, marking the use node as an unused node.

As the threshold depth increases, a number of unused nodes comprised in the tree increases and, as the threshold depth may decrease, a number of unused nodes comprised in the tree may decrease.

The data may include one or more tensors.

Virtual areas comprised in the process address space may be managed by one or more groups in response to a grouping instruction to group the virtual areas as the one or more groups, and virtual areas comprised in one of the one or more groups may be concurrently processed with respect to an arbitrary instruction.

In one or more general aspects, an electronic device includes: one or more processors configured to: receive a mapping instruction to map target data onto a process address space, in response to reception of the mapping instruction, mark an unused node in a tree that manages the process address space as a use node to reuse, and map the target data onto a virtual area in the process address space, wherein the tree manages the virtual area onto which the target data is mapped as the use node.

The tree may manage the process address space using a plurality of use nodes corresponding to a plurality of virtual areas in which data is mapped onto the process address space and one or more unused nodes that do not correspond to the plurality of virtual areas.

For the marking of the unused node as the use node to reuse, the one or more processors may be further configured to: set a lock enabling a read operation to the tree, search for a space to be mapped with the target data in the process address space, determine whether the unused node exists in the tree, and in response to the unused node existing in the tree, mark the unused node as the use node.

For the marking of the unused node as the use node to reuse, the one or more processors may be further configured to search for an initial node using the tree and search for the unused node from the initial node using a list indicating an address order of a plurality of virtual areas comprised in the process address space.

Other features and aspects will be apparent from the following detailed description, the drawings, and the claims.

### BRIEF DESCRIPTION OF THE DRAWINGS

FIG. 1 illustrates an example of a memory usage of an application.

FIG. 2 illustrates an example of an electronic device according to one or more embodiments.

FIG. 3 illustrates an example of a process address space and a tree.

FIG. 4 illustrates an example of a memory usage pattern of an application.

FIG. 5 schematically illustrates an example of an operating method of an electronic device according to one or more embodiments.

FIG. 6 is a flowchart illustrating an example of mapping according to one or more embodiments.

FIG. 7 illustrates an example of mapping according to one or more embodiments.

FIG. 8 is a flowchart illustrating an example of unmapping according to one or more embodiments.

FIG. 9 illustrates an example of unmapping according to one or more embodiments.

FIG. 10 illustrates an example of managing virtual areas in a unit of groups in a Linux kernel according to one or more embodiments.

FIG. 11 illustrates an example of describing a tree managing a process address space of a deep learning application according to one or more embodiments.

FIGS. 12A to 12C illustrate examples of memory allocation and deallocation to an operating system of an application according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly used dictionaries, should be interpreted as having a meaning that is consistent with their meaning in the context of the relevant art and the disclosure of the present application, and will not be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, examples will be described in detail with reference to the accompanying drawings. When describing the embodiments with reference to the accompanying drawings, like reference numerals refer to like elements and a repeated description related thereto will be omitted.

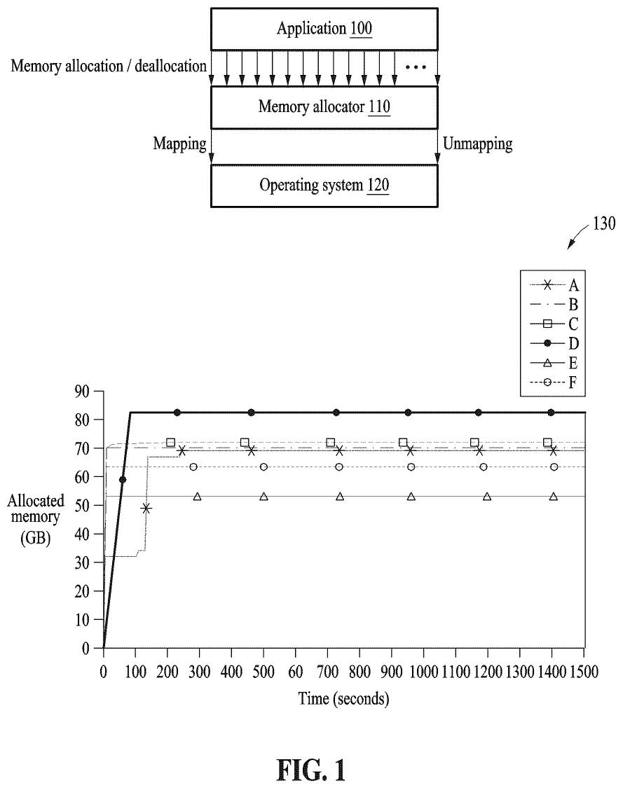

FIG. 1 illustrates an example of a memory usage of an application.

Referring to FIG. 1, a typical application 100 may secure most of the memory from an operating system 120 at startup by using a memory allocator 110 to generate a memory pool. For example, referring to a graph 130, it is illustrated that applications A to F may secure most of the required memory shortly after the applications are executed. Thereafter, the typical application 100 may manage the memory using a memory allocator 110 without support from the operating system 120, thereby the typical operating system 120 may not know (e.g., may not determine) how the application 100 uses the memory. Thus, the typical operating system 120 may not manage the memory in a unit of memory objects but may manage the memory simply in a unit of page.

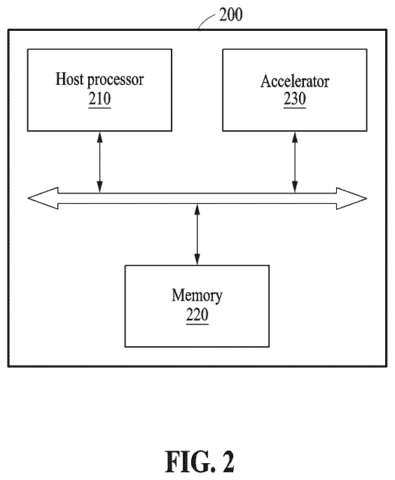

FIG. 2 illustrates an example of an electronic device according to one or more embodiments.

Referring to FIG. 2, an electronic device 200 may include a host processor 210 (e.g., one or more processors), a memory 220 (e.g., one or more memories), and an accelerator 230. The host processor 210, the memory 220, and the accelerator 230 may communicate with each other through a bus, a network on a chip (NoC), a peripheral component interconnect express (PCIe), and the like. In the electronic device 200 of FIG. 2, only the components related to embodiments described herein are illustrated. Thus, it will be apparent to those skilled in the art after an understanding of the present disclosure that the electronic device 200 may also include other general-purpose components, in addition to the components illustrated in FIG. 2.

The host processor 210 may perform overall functions to control the electronic device 200. The host processor 210 may generally control the electronic device 200 by executing programs and/or instructions stored in the memory 220. The host processor 210 may be implemented as a central processing unit (CPU), a graphics processing unit (GPU), an application processor (AP), and the like, which are included in the electronic device 200, but examples are not limited thereto.

The memory 220 may be hardware for storing data processed in the electronic device 200 and data to be processed. In addition, the memory 220 may store an application, a driver, and the like to be driven by the electronic device 200. The memory 220 may include volatile memory (e.g., dynamic random access memory (DRAM)) and/or non-volatile memory. For example, the memory 220 may include a non-transitory computer-readable storage medium storing instructions that, when executed by the host processor 210, configure the host processor 210 to perform any one, any combination, or all of operations and/or methods described herein with reference to FIGS. 1-12C.

The electronic device 200 may include the accelerator 230 for an operation. The accelerator 230 may process tasks that may be more efficiently processed by a separate exclusive processor (that is, the accelerator 230), rather than by the general-purpose host processor 210, due to the characteristics of the tasks. In this case, one or more processing elements (PEs) included in the accelerator 230 may be used. The accelerator 230 may correspond to, for example, a neural processing unit (NPU), a tensor processing unit (TPU), a digital signal processor (DSP), a GPU, a neural engine, and the like that may perform an operation according to a neural network.

An operation of a processor described hereinafter may be performed by the host processor 210.

The processor 210 may provide a process address space to an application when the application is executed by an operating system. The process address space may include a plurality of virtual areas (or regions). The plurality of virtual areas may be mapped with data. The plurality of virtual areas mapped with data may be managed by a tree.

The tree may be used to search a desired virtual area (that is, a target virtual area). In the virtual area mapped with data, mapping with the data may be unmapped when the virtual area is no longer needed. In this case, a node corresponding to the unmapped virtual area may be deleted from the tree. When mapping with new data (e.g., other than the previously mapped data) is required (e.g., determined to be used for an operation), the new data may be mapped onto a new virtual area. A node corresponding to the virtual area newly mapped with the data may be added to the tree.

Whenever a node is added to or deleted from the tree, rebalancing may be performed to maintain a balance of the tree. When rebalancing is performed, a shape of the tree may change. When a node is added to or deleted from the tree, when rebalancing is performed, the entire tree may need to be protected using a single lock. Thus, a typical device and apparatus may not be able to simultaneously allocate or deallocate the memory in a single process address space. Particularly, when multi-threads share a single process address space, memory allocation and deallocation to a multi-thread application may not be simultaneously processed.

Hereinafter, examples of the process address space and the tree described above are further described.

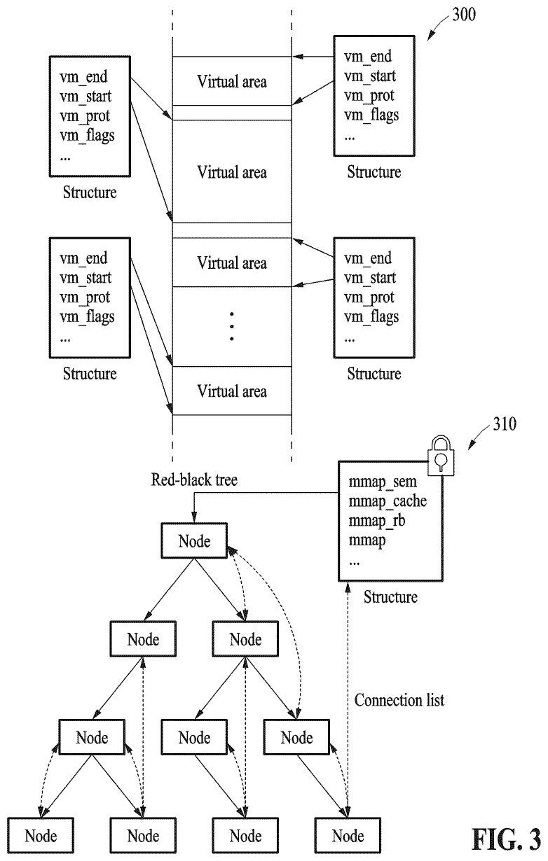

FIG. 3 illustrates an example of a process address space and a tree.

Hereinafter, for ease of description, a process address space 300 and a red-black tree 310 are described based on a Linux kernel. However, since operating systems other than the Linux kernel may also manage a plurality of virtual areas in the process address space 300 by using a tree, it will be apparent to those skilled in the art, after an understanding of the present disclosure, that a description provided hereinafter may apply to other operating systems.

When an application is executed, the process address space 300 may be allocated to the application. The process address space 300 may include a plurality of virtual areas. The plurality of virtual areas may be mapped with data used by the application. The virtual area may be managed by a structure that manages the virtual area. For example, in the Linux kernel, the virtual area may be managed by a vm_area_struct structure (that is, a virtual memory area (VMA)). The structures managing the virtual area may be managed by a structure that manages a process address space. For example, in the Linux kernel, a VMA may be managed by an mm_struct structure managing a process address space. The structure managing the process address space may point to a root node of a tree. The structure managing the process address space may point to a header of a connection list described below.

The structure may include members indicating information, such as a permission, a purpose, and a range of a virtual area. For example, the structure may include a member indicating a start address and an end address of a virtual area managed by the structure. The structure may include a member indicating a subsequent virtual area and a previous virtual area of the virtual area managed by the structure. The structure may include a member related to data mapped onto the virtual area managed by the structure.

The plurality of virtual areas in the process address space 300 may be managed as a tree through a corresponding node. The tree may be a self-balancing binary search tree. Most operating systems may manage a plurality of virtual areas using the self-balancing binary search tree and may search a target virtual area. For example, when an operating system is a Linux kernel, a tree may be the red-black tree 310 that is a self-balancing binary search tree. When an operating system is Windows, a tree may be an adelson-velsky and landis (AVL) tree that is a self-balancing binary search tree. When an operating system is FreeBSD, a tree may be Splay tree that is a self-balancing binary search tree.

A connection list may be used to identify a distance between virtual areas. For example, nodes in the tree may be connected to other nodes with a pointer based on the connection list. The connection list may be an order in which data is mapped onto virtual areas corresponding to the nodes. For example, the connection list may represent an address order of the plurality of virtual areas included in the process address space. Accordingly, the nodes may be connected with a pointer in order of data mapping onto the corresponding virtual areas. For example, a node corresponding to a virtual area on which data is secondly mapped may be connected, with a pointer, to a node corresponding to a virtual area on which data is firstly mapped and a node corresponding to a virtual area on which data is thirdly mapped.

Accordingly, each node of the tree may be connected to pointers for search as well as pointers connected based on the connection list. The tree including pointers connected based on the connection list may be referred to as an augmented tree.

For example, the order of virtual areas in the process address space 300 may increase from bottom to top. Accordingly, in the red-black tree 310, each node may point to a node corresponding to a previous virtual area of a corresponding node and a node corresponding to a subsequent virtual area. In this case, the red-black tree 310 may be an augmented red-black tree.

Each node may be connected to a plurality of pointers in the tree. As described above, each node may have a complex structure because each node is connected to not only pointers but also pointers connected based on the connection list. Since rebalancing is to be performed when a node is removed from or added to the tree, the entire tree may need to be protected by a single lock in order to perform rebalancing. Protecting the process address space 300 with a single lock (e.g., a semaphore lock) may cause a concurrency problem. For example, in a multi-thread environment sharing a single process address space, mapping or unmapping data may be impossible. The memory may need to be mapped and unmapped in the single process address space shared by multi-threads to maximize parallel processing performance. The problem described above may occur in typical operating systems managing the process address space 300.

Hereinafter, a memory usage pattern of an application is described before describing a device and method of one or more embodiments of solving the problem described above.

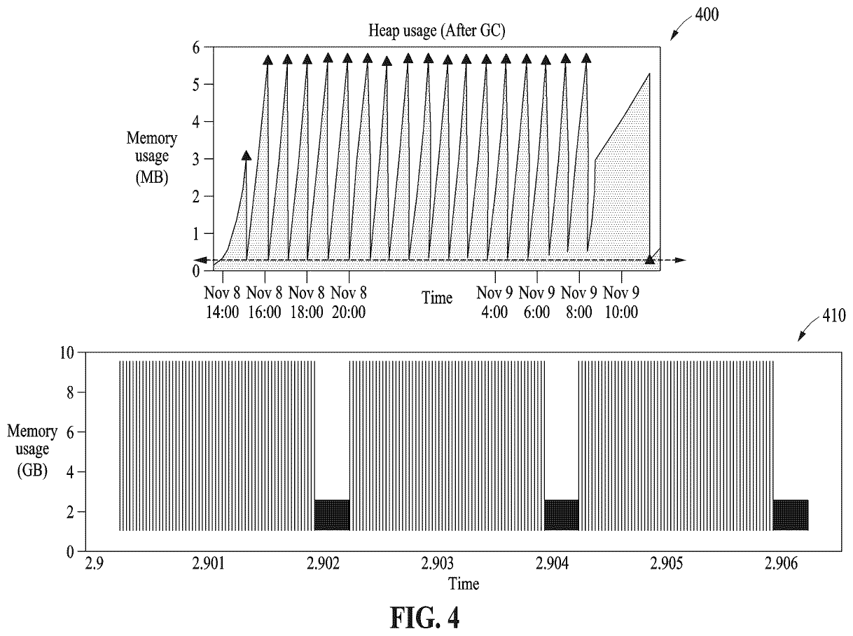

FIG. 4 illustrates an example of a memory usage pattern of an application.

Referring to FIG. 4, a memory usage pattern 400 of a typical application and a memory usage pattern 410 of a deep learning application are illustrated.

Referring to the memory usage pattern 400 of the typical application, the memory usage pattern 400 may have a saw-tooth pattern. For example, mapping and unmapping with respect to a process address space of data may be repeated. Referring to the memory usage pattern 400, when data is mapped onto a process address space little by little and reaches a peak, the data may be unmapped from the process address space all at once. In addition, when the data is mapped onto the process address space little by little and reaches the peak, an operation of unmapping the data from the process address space may be repeated.

Referring to FIG. 4, the memory usage pattern 410 when a deep learning application is trained three times is illustrated. The deep learning application may also use memory similar to the memory usage pattern 400 described above. However, when repeating mapping and unmapping the data, the deep learning application may show a stricter usage pattern than the typical application. The deep learning application may use the same memory in a current iteration as a previous iteration. For example, when 1064 tensors are mapped and 1064 tensors are unmapped in a previous iteration, 1064 tensors may be mapped and 1064 tensors may be unmapped in a current iteration.

As described with reference to FIGS. 2 and 3, the data may be mapped onto a plurality of virtual areas in a process address space and the plurality of virtual areas may be managed by a tree through corresponding nodes. Accordingly, when the data is mapped, nodes may be added to the tree one by one. However, when the data is unmapped from the process address space at once, nodes may be removed from the tree one by one. In addition, when a node is removed from or added to the tree, process rebalancing may be performed after the entire tree is protected by a lock, and a typical device and method may incur a large overhead in removing or adding one node.

Accordingly, hereinafter, a device and method of one or more embodiments of reducing overhead by recycling a node is described.

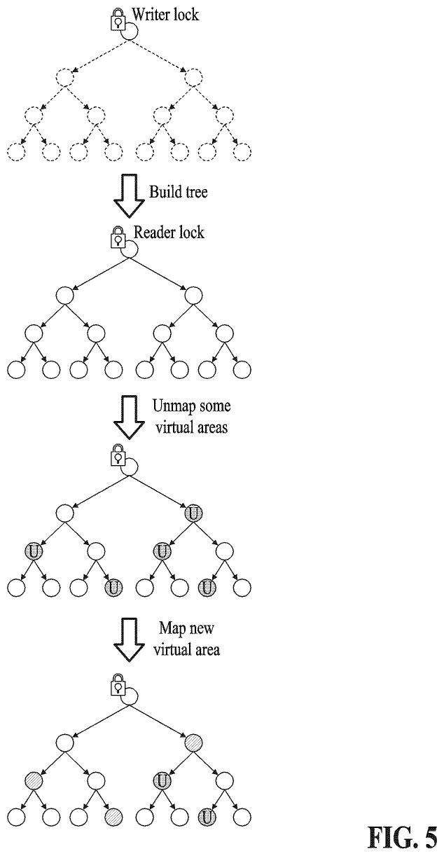

FIG. 5 schematically illustrates an example of an operating method of an electronic device according to one or more embodiments.

Referring to FIG. 5, a method of recycling a node is schematically illustrated.

When an application is executed, the electronic device may allocate a process address space to the application. The electronic device may map data onto the process address space. The electronic device may map data onto a plurality of virtual areas in the process address space. The electronic device may build a tree using a plurality of nodes corresponding to the plurality of virtual areas onto which the data is mapped. The electronic device may set a lock that provides exclusive access to a process address space (or a tree) to one individual (e.g., one thread among multi-threads sharing the tree) obtaining the lock (e.g., a writer lock) among individuals sharing the tree. An individual obtaining the lock may perform a write operation on the process address space (or the tree). For example, when the one thread among the multi-threads obtains the lock described above, the thread may exclusively access the process address space (or the tree).

The tree may be a self-balancing binary search tree. The tree may be an augmented self-balancing binary search tree in which nodes in the tree are connected to each other based on a connection list. For example, the tree may be an augmented red-black tree. According to one or more embodiments, the tree may vary depending on an operating system. When the tree is completed, the electronic device may unlock the lock enabling a write operation to the tree.

When the tree is built, the electronic device may perform unmapping of data on some virtual areas. In this case, the electronic device may set a lock providing permission to at least one individual obtaining the lock (e.g., a reader lock) with concurrent access to the process address space (or the tree) among individuals sharing the tree. The at least one individual obtaining the lock may perform a read operation on the process address space (or the tree). For example, when at least one of multi-threads obtains the lock described above, the at least one thread may concurrently access the process address space (or the tree).

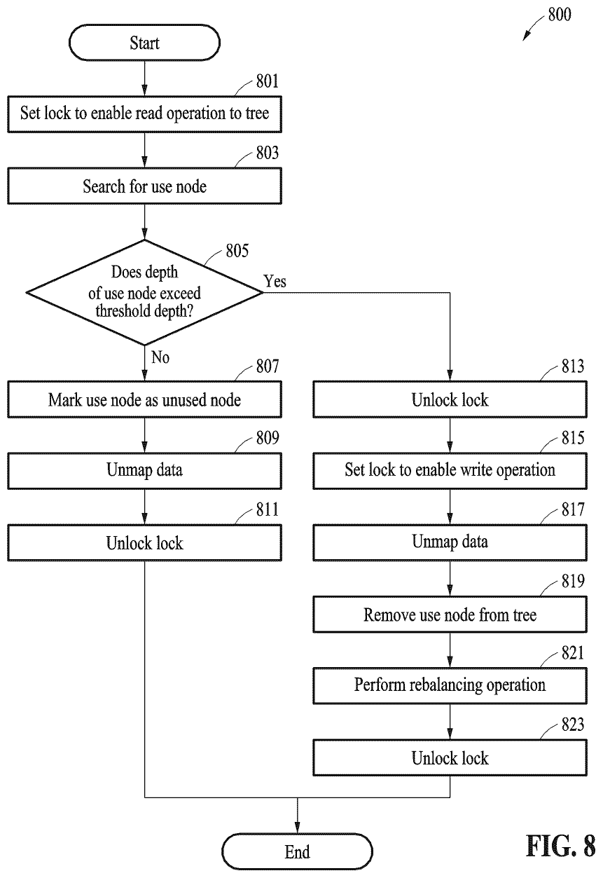

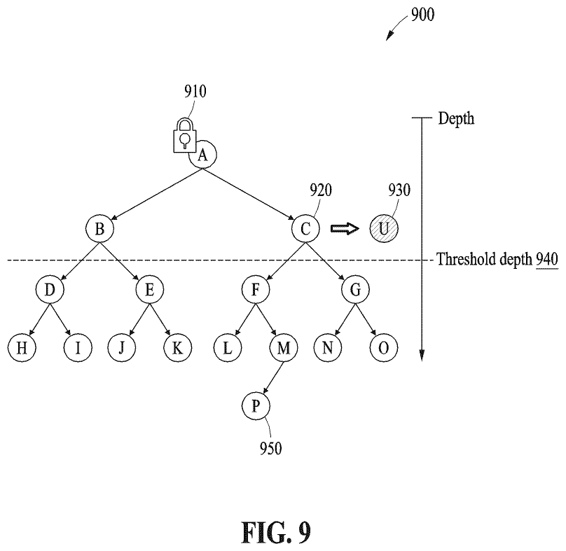

The electronic device may mark, as unused, nodes corresponding to some virtual areas to be unmapped instead of removing the nodes from the tree (e.g., marked as “U” in FIG. 5). When a node is not removed, rebalancing may not need to be performed on the tree. The nodes corresponding to some virtual areas to be unmapped may not be removed from the tree and may remain as unused nodes. On the other hand, for some virtual areas, the mapping of data may be canceled. To distinguish an unused node, which is a node corresponding to a virtual area that is unmapped or to be unmapped, a node corresponding to a virtual area in which mapping is not canceled may be referred to as a use node. An example of a method of unmapping data is further described with reference to FIGS. 8 and 9.

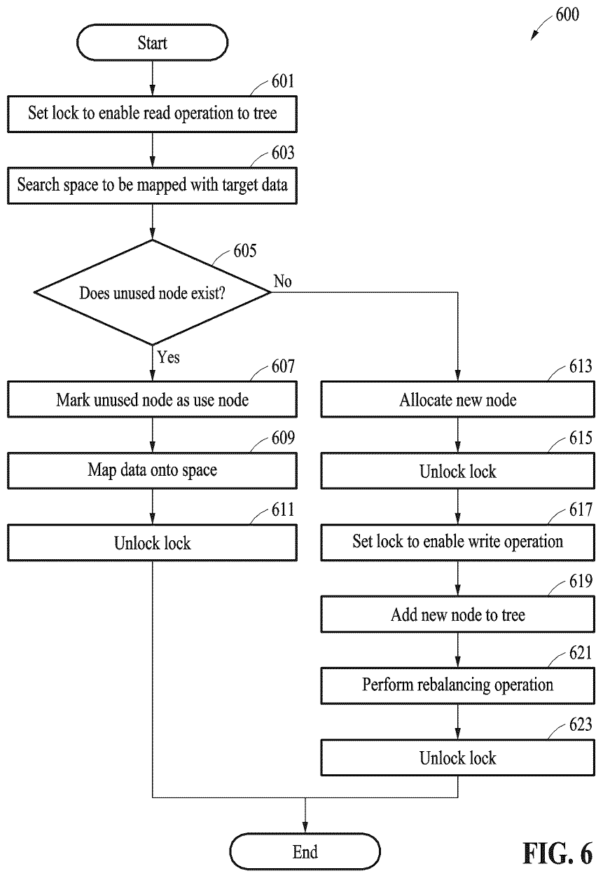

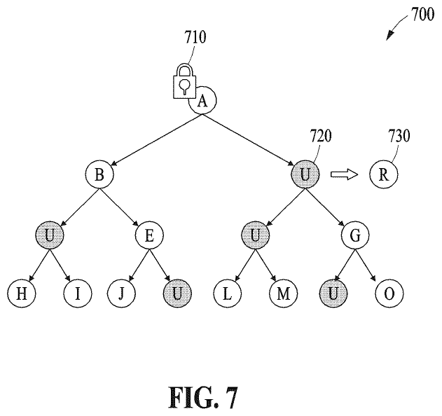

Thereafter, the data may be mapped onto the process address space again. The electronic device may map data onto virtual areas in the process address space. In this case, the virtual areas to be mapped with data may be generated between virtual areas onto which data is previously mapped in the process address space. The electronic device may mark at least one unused node as a use node in the tree. The electronic device may map data onto virtual areas generated between virtual areas onto which data is previously mapped. The virtual areas mapped with data may be managed as nodes marked as a use node from an unused node. For example, by recycling the unused node without adding a node to the tree, the device and method of one or more embodiments may map data onto the tree without performing rebalancing on the tree. An example of a method of re-mapping data onto a process address space is further described with reference to FIGS. 6 and 7.

FIG. 6 is a flowchart illustrating an example of mapping according to one or more embodiments.

Operations to be described hereinafter may be sequentially performed but not necessarily. For example, the order of the operations may change, and at least two of the operations may be performed in parallel. Operations illustrated in a flowchart 600 may be performed by at least one component (e.g., the host processor 210 of FIG. 2) of an electronic device (e.g., the electronic device 200 of FIG. 2).

When the electronic device receives an instruction to map target data in a process address space, the electronic device may perform the following operations.

In operation 601, the electronic device may set a lock to enable a read operation to a tree. The electronic device may use a lock providing a single-writer and multi-readers. In operation 601, the electronic device may allow multi-threads to simultaneously access the tree using multi-readers of the lock. The multi-threads may be able to read the tree to which the lock is set.

The tree may include a plurality of use nodes corresponding to a plurality of virtual areas in which data is mapped onto the process address space. The tree may include at least one unused node that does not correspond to a plurality of virtual areas. The unused nodes may not correspond to the plurality of virtual areas in the process address space and may be intended to maintain only the shape of the tree and thereby may be referred to as shell nodes.

The tree may be a self-balancing binary search tree. The tree may vary depending on an operating system. For example, when the operating system is a Linux kernel, the tree may be a red-black tree. According to one or more embodiments, the tree may be an augmented self-balancing binary search tree in which nodes in the tree are connected to each other in an order in which a virtual area corresponding to each node is mapped. For example, the tree may be an augmented red-black tree.

In operation 603, the electronic device may search a space to be mapped with target data.

The electronic device may search a space to be mapped with the target data in the process address space. The electronic device may identify a free space using a start address and an end address of two adjacent virtual areas. The electronic device may determine whether the free space is sufficient to map the target data. When the free space is sufficient, the electronic device may map the target data by generating a virtual area between the two adjacent virtual areas. When the space is insufficient to map the target data, the electronic device may perform the same operation until the free space is found.

In operation 605, the electronic device may determine whether an unused node exists in the tree. The electronic device may determine whether an unused node to reuse exists in the tree. Depending on whether the unused node to reuse exists in the tree, the electronic device may map the target data by operating in a fast path (e.g., operations 607, 609, and 611) or a slow path (e.g., operations 613, 615, 617, 619, 621, and 623). The fast path and the slow path may be determined based on whether rebalancing is performed.

Hereinafter, a case in which a fast path is operated as an unused node to reuse exists in the tree is described.

In operation 607, when an unused node exists, the electronic device may mark the unused node as a use node. When an unused node exists in the tree, the electronic device may recycle the unused node and may not add a new node to the tree. Accordingly, since there is no need to add a new node, rebalancing may not be performed.

When two or more unused nodes exist, the electronic device may determine an unused node to be marked as a use node from among the two or more unused nodes. The electronic device may search for an initial node in the tree. The search for the initial node may be determined based on an address indicated by an application system. The electronic device may search for an unused node to reuse from the initial node. For example, the electronic device may search for a node to reuse from the initial node based on a connection list. Starting with the initial node, the electronic device may search for an unused node in order of being pointed based on the connection list.

In operation 609, the electronic device may map the target data onto a virtual area in a space searched in operation 603.

In operation 611, the electronic device may unlock the lock. For example, the electronic device may unlock the lock enabling a read operation to a tree.

Hereinafter, a case in which a slow path is operated as an unused node to reuse does not exist in the tree is described.

In operation 613, when an unused node does not exist in the tree, the electronic device may allocate a new node.

In operation 615, the electronic device may unlock the lock. For example, the electronic device may unlock a lock enabling a read operation to a tree.

In operation 617, the electronic device may set a lock to the tree to enable a write operation. The electronic device may allow only one thread to access the tree through a lock providing a single-writer.

In operation 619, the electronic device may add the allocated new node to the tree.

In operation 621, since the new node is added to the tree, the electronic device may perform rebalancing.

The electronic device may map the target data onto a virtual area searched in operation 603. The virtual area mapped with the target data may be managed in correspondence with the new node added to the tree.

In operation 623, the electronic device may unlock the lock to enable the write operation.

Hereinafter, a fast path is described among the operations described above using the tree.

FIG. 7 illustrates an example of mapping according to one or more embodiments.

Referring to FIG. 7, a tree 700 is illustrated.

The tree 700 may include a plurality of use nodes and at least one unused node. For example, the tree 700 may include a node A, a node B, a node E, nodes G to J, a node L, a node M, and a node O, which are the plurality of use nodes. In FIG. 7, the unused nodes may be marked as U. Nodes except for the unused nodes may be referred to as use nodes to distinguish from the unused nodes. The plurality of use nodes may correspond to a plurality of virtual areas in the process address space.

A lock 710 may be set to the tree 700 to enable a read operation. The electronic device may search for a space to be mapped with the target data in the process address space. When the plurality of unused nodes is included in the tree 700, the electronic device may determine an unused node to be marked as a use node among the plurality of unused nodes. Starting with the initial node, the electronic device may search for an unused node using a list indicating an address order (e.g., as indicated by the pointers shown in FIG. 7) of the plurality of virtual areas in the process address space. The initial node may be indicated by an operating system. In a non-limiting example, the electronic device may determine, as the unused node to be marked as the use node, an unused node among the plurality of unused nodes having a shallowest depth among depths of the unused nodes, where the depths are indicated by the list indicating the address order. For example, in FIG. 7, the unused node 720 may be determined as the unused node to be marked as the use node when the unused node 720 is the first unused node among the plurality of unused nodes in a direction of the pointers.

When an unused node 720 is determined, the unused node 720 may be marked as a use node 730. The use node 730 may correspond to a virtual area onto which the target data is mapped. For example, the tree may manage the virtual area, onto which the target data is mapped, as the use node 730.

FIG. 8 is a flowchart illustrating an example of unmapping according to one or more embodiments.

Operations to be described hereinafter may be sequentially performed but not necessarily. For example, the order of the operations may change, and at least two of the operations may be performed in parallel. Operations illustrated in a flowchart 800 may be performed by at least one component (e.g., the host processor 210 of FIG. 2) of an electronic device (e.g., the electronic device 200 of FIG. 2).

When the electronic device receives an unmapping instruction to cancel the mapping of data for a target virtual area in a process address space, the electronic device may perform the following operations.

In operation 801, the electronic device may set a lock to enable a read operation to a tree. In regard to setting a lock to enable a write operation by the electronic device, the description thereof is provided with reference to FIG. 6, and thus, is omitted.

In operation 803, the electronic device may search for a use node. The electronic device may search for a use node corresponding to a target virtual area to unmap the data.

In operation 805, the electronic device may determine whether a depth of the use node exceeds a threshold depth. An example of the threshold depth is further described with reference to FIG. 9.

The electronic device may operate as a fast path (e.g., operations 807, 809, and 811) or a slow path (e.g., operations 813, 815, 817, 819, 821, and 823) depending on whether the depth of the use node exceeds the threshold depth. In this case, the fast path and the slow path may be determined based on whether rebalancing is performed.

Hereinafter, a fast path without performing rebalancing is described.

In operation 807, the electronic device may mark a searched use node as an unused node. The electronic device may not remove the searched use node from the tree and may mark the searched use node as an unused node. The searched use node marked as an unused node may remain in the tree to be reused in the future. Accordingly, since a node is not removed from the tree, rebalancing may not be performed.

In operation 809, the electronic device may unmap the data from the target virtual area.

In operation 811, the electronic device may unlock the lock. For example, the electronic device may unlock the lock enabling a read operation to a tree.

Hereinafter, a case in which a slow path is operated as the depth of the searched use node exceeds the threshold depth is described.

In operation 813, the electronic device may unlock a lock enabling a read operation to a tree.

In operation 815, the electronic device may set a lock to enable a write operation. The electronic device may allow only one thread to access the tree through a lock providing a single-writer.

In operation 817, the electronic device may unmap the data from the target virtual area.

In operation 819, the electronic device may remove a use node corresponding to the target virtual area from the tree.

In operation 821, the electronic device may perform rebalancing on the tree.

Unlike operation 807, since the use node is removed in operation 819, rebalancing may be performed to maintain a balance of the tree.

In operation 823, the electronic device may unlock a lock enabling a write operation.

Hereinafter, a fast path is described among the operations described above using the tree.

FIG. 9 illustrates an example of unmapping according to one or more embodiments.

Referring to FIG. 9, a tree 900 is illustrated.

The tree 900 may include a plurality of use nodes. For example, the tree 900 may include nodes A to P, which are the plurality of use nodes. In FIG. 9, unused nodes may be marked as U. The plurality of use nodes may correspond to a plurality of virtual areas in the process address space.

A lock 910 may be set to the tree 900 to enable a read operation. The electronic device may search for a use node corresponding to a target virtual area to unmap the data. The electronic device may determine whether a depth of a searched use node exceeds a threshold depth 940. In a non-limiting examples, a depth of a use node increases in a direction of the pointers.

For example, when a use node corresponding to the target virtual area is a node C 920, the depth of the node C 920 may not exceed the threshold depth 940. Accordingly, the electronic device may map the data by a fast path.

For example, when the use node corresponding to the target virtual area is a node P 950, the depth of the node P 950 may exceed the threshold depth 940. Accordingly, the electronic device may map the data by a slow path.

As described above with reference to FIG. 8, when the depth of the use node corresponding to the target virtual area does not exceed the threshold depth 940, the use node may not be removed and may be marked as an unused node. Accordingly, as the threshold depth 940 increases, the number of unused nodes may increase. Conversely, as the threshold depth 940 decreases, the number of unused nodes may decrease. Accordingly, the unused node may need to be appropriately set. According to one or more embodiments, when the number of virtual areas included in a process address space is a maximum (e.g., when the data is mapped onto the process address space at maximum), the threshold depth 940 may be set to be a depth that may include all nodes corresponding to the virtual areas. For example, referring to the memory usage patterns 400 and 410 of FIG. 4, when an amount of memory usage is maximum, the threshold depth 940 may be set to be a depth that may include all nodes corresponding to virtual areas included in a process address space.

Hereinafter, a method of managing virtual areas in the unit of groups is described.

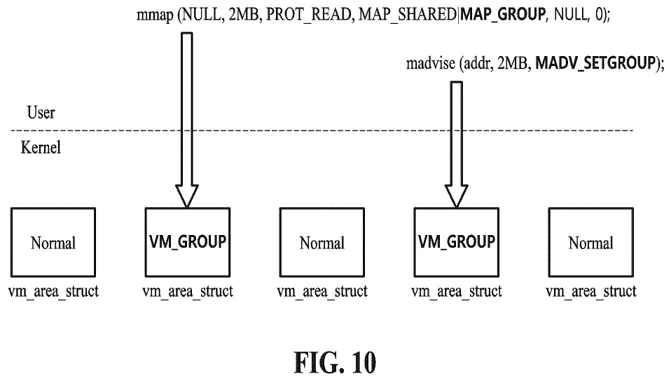

FIG. 10 illustrates an example of managing virtual areas in a unit of groups in a Linux kernel according to one or more embodiments.

Hereinafter, for ease of description, a method of managing virtual areas in the unit of groups is described based on a Linux kernel. However, it is obvious to those skilled in the art that in operating systems other than the Linux kernel, virtual areas may be managed in the unit of groups using a flag described below.

Mapping or unmapping the target data onto the process address space may be performed in the unit of groups of virtual areas. The virtual area may be managed by a structure. The structure may include members indicating information on a permission, a purpose, a range of the virtual area, and the like. The structure may include various flags indicating properties of the virtual area as members. For example, a vm_area_struct structure managing a virtual area (e.g., a VMA) in the Linux kernel may include various flags (e.g., VM_SEQ_READ and VM_RAND_READ) showing a feature of the virtual area.

Accordingly, a flag (e.g., VM_GROUP) indicating that a virtual area may be managed as a group with other virtual areas may be added to the structure managing the virtual area. For example, a flag indicating that a virtual area may be managed with other virtual areas in the unit of groups may be added to the structure.

According to one or more embodiments, when a group flag is included in a structure of a virtual area onto which data is mapped or unmapped, the data may be mapped onto or unmapped from other virtual areas grouped by the group flag. In addition, when a page fault occurs, a page fault handler may process in the unit of groups rather than in the unit of pages. Accordingly, when the electronic receives a mapping instruction to map target data onto the process address space or an unmapping instruction to unmap the target data and a virtual area to be mapped or unmapped with the target data is managed by a group flag, mapping or unmapping may be performed together on virtual areas grouped by the group flag. Eventually, nodes of the tree corresponding to the virtual areas grouped by the group flag may be processed together. For example, nodes of the tree corresponding to the virtual areas grouped by the group flag may be managed together. For example, nodes of the tree corresponding to the virtual areas grouped by the group flag may be marked as unused nodes or use nodes.

However, a typical system call may need to expand for the operations described above. According to one or more embodiments, by adding to a mapping instruction to map data, a flag (e.g., MAP_GROUP) to group a virtual area onto which the data is mapped with other virtual areas, a group flag may be added to the structure of the virtual area onto which the data is mapped. According to one or more embodiments, by using an instruction added with a flag (e.g., MADV_SETGROUP) to group a virtual area that is previously mapped with data with other virtual areas and manage the virtual area, a group flag may be added to a structure of the virtual area that is previously mapped. According to one or more embodiments, for a plurality of virtual areas grouped and managed, by using an instruction added with a flag (e.g., MADV_UNSETGROUP) to cancel grouping, the grouping of the plurality of virtual areas grouped and managed may be canceled.

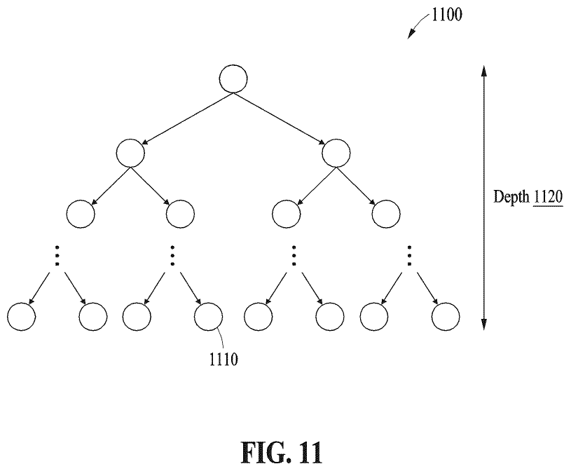

FIG. 11 illustrates an example of describing a tree managing a process address space of a deep learning application according to one or more embodiments.

When an electronic device executes an application, the electronic device may allocate a process address space to the application. In this case, the application may be a deep learning application. Thousands of tensors may be used for training or inference of the deep learning application. Accordingly, when an application executed herein is a deep learning application, the data described with reference to FIGS. 5 to 9 may include at least one tensor.

For example, when Swin-transform, which is one of representative deep learning applications, learns a deep learning model, 1064 tensors may be mapped and unmapped for each iteration as described in the memory usage pattern 410 of FIG. 4. In addition, not only iteratively mapped and unmapped tensors but also 1232 virtual areas onto which data for maintaining the application is mapped may exist. Accordingly, even if 1064 tensors are mapped onto respective virtual areas, a total of 2296 virtual areas may be regularly required. Accordingly, using the method described with reference to FIGS. 5 to 9, depending on mapping or unmapping of data (e.g., at least one tensor), rebalancing may not be performed as a node does not need to be added to or removed from the tree, mapping or unmapping tensors may be rapidly performed.

In addition, to manage virtual areas for iteratively mapped or unmapped tensors and virtual areas onto which data for maintaining the deep learning application is mapped, the tree may manage nodes corresponding to the virtual areas using the method described with reference to FIGS. 5 to 9.

For example, when a total of 2296 virtual areas are regularly required, a tree 1100 may manage a plurality of nodes including 2296 nodes corresponding to the 2296 virtual areas using the method described with reference to FIGS. 5 to 9. For example, a node 1110 may be a 2296th node. For example, the tree 1100 may manage a plurality of nodes existing up to a depth 1120 including the node 1110 using the method described with reference to FIGS. 5 to 9.

As the memory usage pattern of the deep learning application of FIG. 4, the same number of tensors are mapped or unmapped each time. Although more tensors need to be mapped, the depth may deepen by only one level in the tree 1100. Accordingly, although many nodes are maintained in the tree 1100, the cost for maintaining the nodes may not be significant.

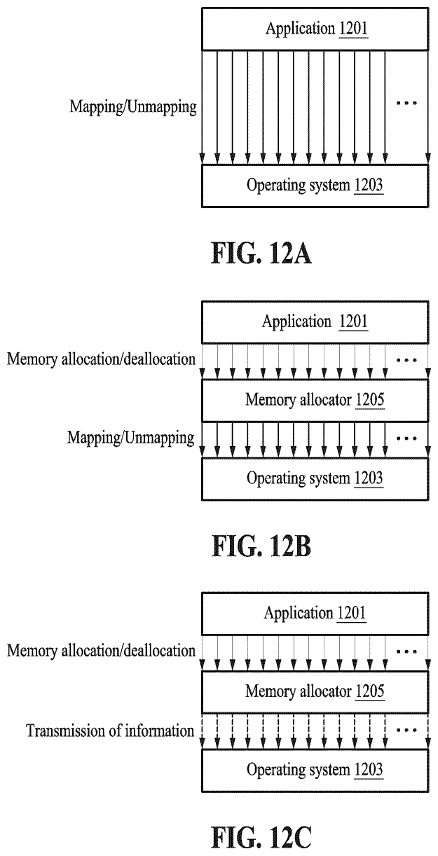

FIG. 12 illustrates an example of memory allocation and deallocation to an operating system of an application according to one or more embodiments.

As described in FIG. 1, an application 1201 may secure a memory pool first and then may perform allocation and deallocation of memory by itself. Allocating or deallocating memory directly from an operating system 1203 may cause large overhead and may be inefficient.

However, when using the method of managing a process address space of the application 1201 described herein, the application 1201 may request the operating system 1203 for direct allocation or deallocation of memory. However, for this, modification of an existing application may be required.

For example, referring to FIG. 12A, the application 1201 may request the operating system 1203 for direct allocation or deallocation of the memory. However, in this case, since allocation or deallocation of the memory is directly requested to the operating system 1203, the memory may be allocated through a memory mapping function or a memory unmapping function other than an existing memory allocation function or an existing memory deallocation function, thereby modification of the application 1201 may be required to identify this.

For example, referring to FIG. 12B, to prevent modification of the application 1201, a memory allocator 1205 may transmit a memory allocation function of the application 1201 or a memory mapping function corresponding to a memory allocation function instruction, or a memory unmapping function to the operating system 1203. In this case, the memory allocator 1205 may not secure a memory pool for the application 1201 in advance and may process a memory allocation function or a memory deallocation function respectively through a memory mapping instruction or a memory unmapping instruction. This may simplify a logic of the memory allocator 1205 and may obtain performance improvement.

For example, referring to FIG. 12C, a memory pool may be managed in a similar manner to FIG. 12B. The memory allocator 1205 may secure a memory pool for the application 1201 in advance and when a memory allocation function or a memory deallocation function is received from the application 1201, the memory allocator 1205 may internally allocate or deallocate the memory in the method shown in FIG. 1. the memory allocator 1205 may transmit information on memory allocation or memory deallocation to the operating system 1203.

According to the embodiments of the present disclosure, the operating system may recognize how the application uses the memory and may efficiently manage data in a complex memory system.

The memory allocators, electronic devices, host processors, memories, accelerators, memory allocator 110, electronic device 200, host processor 210, memory 220, accelerator 230, and memory allocator 1205 described herein, including descriptions with respect to respect to FIGS. 1-12C, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12C that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
receiving a mapping instruction to map target data onto a process address space;
in response to reception of the mapping instruction, marking an unused node in a tree that manages the process address space as a use node to reuse; and
mapping the target data onto a virtual area in the process address space,
wherein the tree manages the virtual area onto which the target data is mapped as the use node.

2. The method of claim 1, wherein the tree manages the process address space using a plurality of use nodes corresponding to a plurality of virtual areas in which data is mapped onto the process address space and one or more unused nodes that do not correspond to the plurality of virtual areas.

3. The method of claim 1, wherein the tree comprises a self-balancing binary search tree.

4. The method of claim 1, wherein the marking of the unused node as the use node to reuse comprises:
setting a lock enabling a read operation to the tree;
searching for a space to be mapped with the target data in the process address space;
determining whether the unused node exists in the tree; and
in response to the unused node existing in the tree, marking the unused node as the use node.

5. The method of claim 4, wherein the marking of the unused node as the use node to reuse comprises:
searching for an initial node using the tree and searching for the unused node from the initial node using a list indicating an address order of a plurality of virtual areas comprised in the process address space.

6. The method of claim 1, wherein the data comprises one or more tensors.

7. The method of claim 1, wherein virtual areas comprised in the process address space are managed by one or more groups in response to a grouping instruction to group the virtual areas as the one or more groups, and
virtual areas comprised in one of the one or more groups are concurrently processed with respect to an arbitrary instruction.

8. The method of claim 1, further comprising:
receiving an unmapping instruction to cancel mapping of data for a target virtual area in the process address space;
in response to reception of the unmapping instruction, marking another use node in the tree as another unused node; and
unmapping data for the target virtual area,
wherein the tree manages the other unused node to reuse in future.

9. A non-transitory computer-readable storage medium storing instructions that, when executed by one or more processors, configure the one or more processors to perform the method of claim 1.

10. A processor-implemented method comprising:
receiving an unmapping instruction to cancel mapping of data for a target virtual area in a process address space;
in response to reception of the unmapping instruction, marking a use node in a tree corresponding to the target virtual area as an unused node; and
unmapping data for the target virtual area,
wherein the tree manages the unused node to reuse in future.

11. The method of claim 10, wherein the tree manages the process address space using a plurality of use nodes corresponding to a plurality of virtual areas in which data is mapped onto the process address space and one or more unused nodes that do not correspond to the plurality of virtual areas.

12. The method of claim 10, wherein the tree comprises a self-balancing binary search tree.

13. The method of claim 10, wherein the marking of the use node as an unused node comprises:
setting a lock enabling a read operation to the tree;
searching for the use node corresponding to the target virtual area in the tree;
determining whether a depth of the use node searched in the tree exceeds a threshold depth; and
in response to the depth of the searched use node not exceeding the threshold depth, marking the use node as an unused node.

14. The method of claim 13, wherein, as the threshold depth increases, a number of unused nodes comprised in the tree increases and, as the threshold depth decreases, a number of unused nodes comprised in the tree decreases.

15. The method of claim 10, wherein the data comprises one or more tensors.

16. The method of claim 10, wherein virtual areas comprised in the process address space are managed by one or more groups in response to a grouping instruction to group the virtual areas as the one or more groups, and
virtual areas comprised in one of the one or more groups are concurrently processed with respect to an arbitrary instruction.

17. An electronic device comprising:
one or more processors configured to:
receive a mapping instruction to map target data onto a process address space,
in response to reception of the mapping instruction, mark an unused node in a tree that manages the process address space as a use node to reuse, and
map the target data onto a virtual area in the process address space,
wherein the tree manages the virtual area onto which the target data is mapped as the use node.

18. The electronic device of claim 17, wherein the tree manages the process address space using a plurality of use nodes corresponding to a plurality of virtual areas in which data is mapped onto the process address space and one or more unused nodes that do not correspond to the plurality of virtual areas.

19. The electronic device of claim 17, wherein, for the marking of the unused node as the use node to reuse, the one or more processors are further configured to:
set a lock enabling a read operation to the tree,
search for a space to be mapped with the target data in the process address space,
determine whether the unused node exists in the tree, and
in response to the unused node existing in the tree, mark the unused node as the use node.

20. The electronic device of claim 19, wherein, for the marking of the unused node as the use node to reuse, the one or more processors are further configured to search for an initial node using the tree and search for the unused node from the initial node using a list indicating an address order of a plurality of virtual areas comprised in the process address space.
